(19) United States
(12) Patent Application Publication
(10) Pub. No.: US 2010/0064321 A1
(43) Pub. Date: Mar. 11, 2010

(54) SYSTEM AND METHOD FOR PROCESSING ELECTRONIC PROGRAM GUIDE BASED ON REALLY SIMPLE SYNDICATION FEED

(76) Inventors: Won Suk Lee, Daejeon (KR); Kangchan Lee, Daejeon (KR); Jong Hong Jeon, Daejeon (KR); Seung Yun Lee, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/518,204

(22) PCT Filed: Dec. 6, 2007
(86) PCT No.: PCT/KR07/06304

§ 371 Date: Jun. 8, 2009

(30) Foreign Application Priority Data
Dec. 8, 2006 (KR) 10-2006-0124275

(51) Int. Cl. H04N 5/445

(52) U.S. Cl. 725/46; 725/48; 725/53

(57) ABSTRACT

An RSS (really simple syndication) feed based EPG (electronic program guide) processing system includes: a plurality of user devices; a plurality of television program servers for providing EPG information of television channels via the Internet; and an EPG processing server for receiving a user's demand from a user device and for providing to the user device user-specific EPG information according to the user's demand. In the EPG processing system, a plurality of first RSS feeds, for interoperating with the television program servers via the Internet, are registered to the EPG processing server. The EPG processing server obtains and stores the EPG information of each television channel by using each of the first RSS feeds, generates the user-specific EPG information corresponding to the user's demand by searching for the stored EPG information according to the user's demand, and provides the user-specific EPG information to the user device.

### TECHNICAL FIELD

The present invention relates to a system and method for efficiently processing, based on RSS (Really Simple Syndication) feeds, an EPG (Electronic Program Guide) of a TV (Television) program in an IPTV (Internet Protocol Television) service environment.

### BACKGROUND ART

IPTV services broadcast TV programs via the Internet, and also, in conjunction with existing Internet services, provide more convenient services.

In such IPTV services, the number of TV channels tends to be increased by geometric progression in comparison with other service environments. Therefore, it is required to provide services which allow users to easily navigate user-desired TV programs and reconstruct the TV programs in a user-desired form.

As the digital age accelerates, a single user becomes to use larger number of electronic devices. Further, the electronic devices are being developed to devices capable of accessing the Internet with the development of technologies. Accordingly, when the IPTV services are provided through the various devices capable of accessing the Internet, the TV interface through which an EPG service once set by a user is provided needs to be also provided consistently with other devices capable of accessing the Internet.

Moreover, under environments where EPG information of TV programs are transmitted together with broadcasting content data, e.g., the DMB (Digital Multimedia Broadcasting) service environment as well as existing broadcasting service environments such as the terrestrial TV service environment and the cable TV service environment, methods for providing more convenient services in conjunction with the existing Internet services to users are necessary when devices can access the Internet.

### DISCLOSURE OF INVENTION

### Technical Problem

In view of the above, the present invention provides a system and method for processing an EPG based on RSS feeds, the system and method capable of providing more convenient service environment to a user in an IPTV environment by generating a user-specific EPG by reconstructing EPG information of TV programs and content information relating to each TV program according to a user's demand and providing the user-specific EPG to the user.

### Technical Solution

In accordance with one aspect of the invention, there is provided an RSS (really simple syndication) feed based EPG (electronic program guide) processing system, including:

a plurality of user devices;

a plurality of television program servers for providing EPG information of television channels via the Internet; and

an EPG processing server for receiving a user's demand from a user device and for providing to the user device user-specific EPG information according to the user's demand,

wherein a plurality of first RSS feeds, for interoperating with the television program servers via the Internet, are registered to the EPG processing server; and

wherein the EPG processing server obtains and stores the EPG information of each television channel by using each of the first RSS feeds, generates the user-specific EPG information corresponding to the user's demand by searching for the stored EPG information according to the user's demand, and provides the user-specific EPG information to the user device.

In accordance with another aspect of the invention, there is provided an RSS (really simple syndication) feed based EPG (electronic program guide) processing method for use in an EPG processing server, the server generating user-specific electronic program guide information according to a user's demand by using EPG information of television channels provided by a plurality of television program servers via the Internet and providing the user-specific EPG information to a user device, including:

registering a first RSS feed for each of the television channels;

obtaining and storing the EPG information using the first RSS feeds;

searching for, when receiving from the user device selection information corresponding to the user-specific EPG information, the stored EPG information based on the selection information; and

generating and providing the user-specific EPG information to the user device.

### ADVANTAGEOUS EFFECTS

In accordance with the present invention, EPG information of TV programs and content information relating to each TV program are obtained using RSS feeds and converted to user-specific EPG information according to device profile. Then the user-specific EPG information is provided to a user. By obtaining the information using the RSS feeds, classification and processing or the information can be facilitated, and also, the user can be provided with more convenient environment.

Further, users can search various bulletin boards relating to TV programs easily and exchange opinions with each other in real time via the bulletin boards. In addition, users can make contracts such as open bids with sellers via real time opinion exchanges.

Moreover, natural bidirectional services can be provided via the RSS standard based interoperability between Internet services relating to TV programs.

### BRIEF DESCRIPTION OF THE DRAWINGS

The above features of the present invention will become apparent from the following description of an embodiment, given in conjunction with the accompanying drawings, in which:

FIG. 1 illustrates a schematic configuration view of an RSS feed based EPG processing system for processing an EPG based on RSS feeds in an IPTV environment in accordance with an embodiment of the present invention;

FIG. 2 illustrates a flow chart of a procedure in which an EPG processing server obtains EPG information of TV programs and content information relating to each TV program by using the RSS feeds and generates user-specific EPG information in accordance with the embodiment of the present invention; and

FIG. 3 illustrates a flow chart of a procedure in which the EPG processing server generates and provides the user-specific EPG information according to a user device profile.

### BEST MODE FOR CARRYING OUT THE INVENTION

Embodiments of the present invention will be described in detail with reference to the accompanying drawings, which form a part hereof.

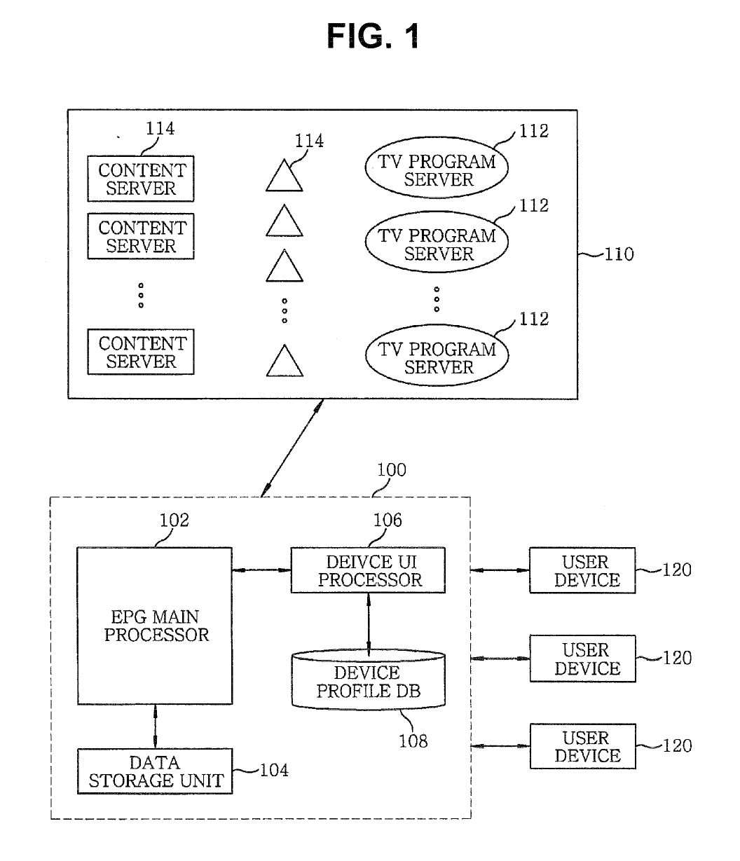

FIG. 1 illustrates a schematic configuration view of an RSS feed based EPG processing system for processing an EPG based on RSS feeds in an IPTV environment in accordance with an embodiment of the present invention.

Referring to FIG. 1, an RSS based EPG processing server (hereinafter, referred to as “EPG processing server”) 100 generates EPG information (hereinafter, referred to as “user-specific EPG information”) reconstructed according to user's demand based on EPG information provided by various TV program servers 112 on the Internet 110, converts the user-specific EPG information according to a profile of each user device 120, and then provides the converted user-specific EPG information to a corresponding user device 120. Accordingly, a user can be provided with consistent services even when the user uses various user devices 120 such as a cellular phone, a PDA (Personal Digital Assistant), a TV, and the like.

On the Internet 110, as well as the EPG information provided by the various TV program servers 112, there exist content information relating to TV programs provided by various content servers 114. Integration of the EPG information and the content information is carried out by using RSS feeds which are RSS documents. That is, content service providers register RSS feeds for content information relating to TV programs to the EPG processing server 100 and update the RSS feeds whenever necessary. For example, if a content service provider who manages an Internet shopping mall sells clothing having appeared on a specific TV program, he/she would access the EPG processing server 100 via the Internet 110 and generate RSS feeds about his/her Internet shopping mall and his/her goods (i.e., relating content information) to register the RSS feeds to the EPG processing server 100.

The user devices 120 can access the EPG processing server 100 via a network and can be provided with user-specific EPG information including EPG information of user-desired TV programs and relating content information.

Construction of the user-specific EPG information is carried out in the EPG processing server 100 by using the RSS feeds. Here, the RSS is a standard for registering or setting XML (Extensible Markup Language) based feeds and continuously providing modified or added information via the registered or set RSS feeds.

The EPG processing server 100 includes an EPG main processor 102, a data storage unit 104, a device user interface (UI) processor 106, and a device profile database (DB) 108.

In the EPG main processor 102, RSS feed (hereinafter, referred to as “TV program RSS feeds”) for interoperating with the TV program servers 112 via the Internet 110 are set and registered. The EPG main processor 102 is provided with EPG information of each TV program via the Internet 110 by using the TV program RSS feeds and stores the EPG information in the data storage unit 104.

Further, in the EPG main processor 102, RSS feeds (hereinafter, referred to as “relating content RSS feeds”) for interoperating with content services relating to TV programs are set and registered. The EPG main processor 102 is provided with relating content information via the Internet 110 by using the relating content RSS feeds and links the relating content to the EPG information of corresponding TV program stored in the data storage unit 104. Here, the relating content information are various service information relating to each TV program, e.g., information on goods, communities, and the like.

Accordingly, the data storage unit 104 stores therein the EPG information of each TV program and also the content information relating to the TV program. Here, the TV program RSS feeds have one-to-one correspondence with TV channels, and can be registered by information provider side, e.g., the TV program servers 112, which accesses the EPG processing server 100 via the Internet 110. Alternatively, the EPG main processor 102 of the EPG processing server 100 itself can generate the TV program RSS feeds.

The EPG main processor 102 searches from the data storage unit 104 EPG information and relating content information corresponding to selection information received from the user via the network, and sends them to the device UI processor 106. The device UI processor 106 converts the EPG information and relating content information to generate user-specific EPG information adapted to a profile of the user device 120, and then provides the user-specific EPG information to the user device 120. The EPG main processor 102 may include an acquisition/analyzer for acquiring, by using TV program RSS feeds, and analyzing EPG information which is TV program information of each TV channel; an RSS based information processor for managing and searching for the EPG information; and an RSS based EPG combining processor for representing, displaying, and combining the RSS based EPG in various forms.

Further, the EPG main processor 102 is provided with the selection information corresponding to a user's demand on EPG information. Examples of the selection information are TV program selection information, genre selection information, and the like. Then, the EPG main processor 102 searches for EPG information corresponding to the selection information in the data storage unit 104, and sends to the device UI processor 106 the searched EPG information together with relating content information.

The device profile DB 108 stores therein device profile information of user devices 120. The device profile information includes information on hardware and software environments of the user devices 120.

The device UI processor 106 searches for device profile information of a user device 120 accessing the EPG processing server 100 via the network in the device profile DB 108, and generates user-specific EPG information by converting, based on the device profile information, EPG information received from the EPG main processor 102 and the relating content information. Then, the device UI processor 106 provides the user-specific EPG information to the user device 120.

The EPG information of TV programs and the relating content information, which are included in the user-specific EPG information, are updated by using the TV program RSS feeds and the relating contents RSS feeds, respectively. To be specific, the EPG information and the relating content information stored in the data storage unit 104 are updated as the EPG processing server 100 receives the EPG information and the content information via the TV program RSS feeds and the relating content RSS feeds, respectively. Since the user device 120 receives the user-specific EPG information generated using the updated EPG information, the user device 120 can be provided with updated information.

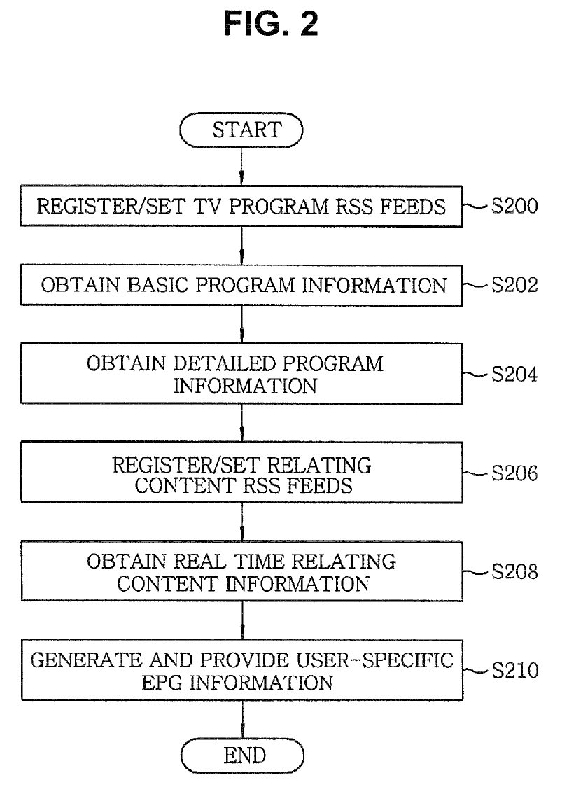

A procedure in which the EPG processing server 100 having the above-described configuration obtains the EPG information by using the RSS feeds and interoperates with relating Internet services will be described below with reference to FIG. 2.

FIG. 2 illustrates a flow chart of a procedure in which an EPG processing server obtains EPG information of TV programs and content information relating to each TV program by using the RSS feeds and generates user-specific EPG information in accordance with the embodiment of the present invention.

In order to receive the EPG information from the TV program EPG generating side, e.g., the TV program servers 112, by using the RSS feeds, the EPG processing server 100 need to have an RSS feed for each TV program server 112 (i.e., each TV channel). Such RSS feeds (hereinafter, referred to as “TV program RSS feeds”) can be registered to the EPG processing server 100 by TV program provider side, e.g., the TV program servers 112, or, the EPG processing server 100 itself can generate the RSS feeds (step S200).

By using the TV program RSS feeds generated or registered as described above, the EPG processing server 100 obtains basic information on each TV program (step S202). Here, the basic program information is obtained via the TV program RSS feeds according to the RSS standard.

Thereafter, the EPG processing server 100 obtains detailed program information on each TV program (step S204). That is, the step S204 is a step for obtaining detailed information on TV programs linked with the basic program information. In particular, various forms of information which are necessary for generating the user-specific EPG information according to the user's demand, need to be obtained in the step S204, and such necessary information can be obtained using various standard techniques according to actual embodiments and circumstances.

Meanwhile, in order to generate linkages for allowing the TV programs to interoperate with the various services and provide an environment in which users can easily searching for the latest information, the EPG processing server 100 needs to have relating content RSS feeds for content information relating to each TV program. For this, relating content providers register RSS feeds for the content relating to each TV program, e.g., information on goods, communities, and the like, to the EPG processing server 100 (step S206).

Subsequently, the EPG processing server 100 is provided with relating content information continuing to be updated using the relating content RSS feeds, thereby obtaining the relating content information in real time (step S208).

After that, the EPG processing server 100 generates the user-specific EPG information adapted to the type of the user device 120, thus providing to the user the EPG information together with the content information relating to each TV program (step S210). From this, the user can be provided with the EPG information and the relating content information in real time based on the RSS feeds.

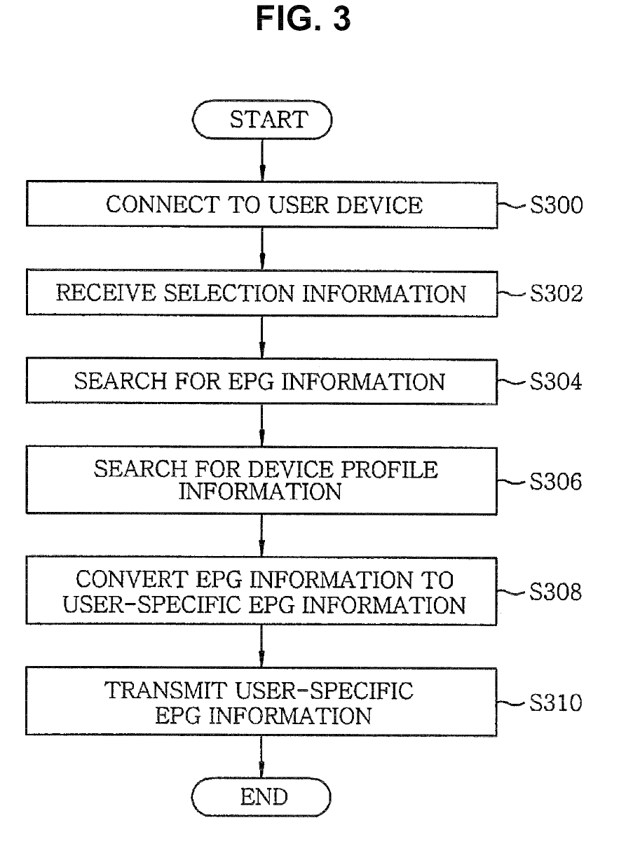

FIG. 3 illustrates a flow chart of a procedure in which the EPG processing server generates and provides the user-specific EPG information according to a user device profile.

Referring to FIG. 3, a user accesses the EPG processing server 100 via a network by using a user device 120, e.g., a cellular phone (step S300), and provides to the EPG processing server 100 selection information, e.g., information on titles or genres of TV programs (step S302).

The EPG main processor 102 of the EPG processing server 100 searches for EPG information corresponding to the selection information provided by the user in the data storage unit 104 (step S304), and then provides the searched EPG information to the device UI processor 106 together with the relating content information.

Thereafter, the device UI processor 106 searches for profile information of the user device 120, i.e., profile information of the cellular phone, of the user who requests user-specific EPG information generation in the device profile DB 108 (step S306).

The device UI processor 106 generates the user-specific EPG information by converting the EPG information received from the EPG main processor 102 and the relating content information using the profile information (step S308). Then, the device UI processor 106 provides the user-specific EPG information to the user device 120 (step S310).

In accordance with the present invention, EPG information of TV programs and content information relating to each TV program are obtained using RSS feeds and converted to user-specific EPG information according to device profile. Then the user-specific EPG information is provided to a user. By obtaining the information using the RSS feeds, classification and processing or the information can be facilitated, and also, the user can be provided with more convenient environment.

While the invention has been shown and described with respect to the embodiments, it will be understood by those skilled in the art that various changes and modification may be made without departing from the scope of the invention as defined in the following claims.

1. An RSS (really simple syndication) feed based EPG (electronic program guide) processing system, comprising:
a plurality of user devices;
a plurality of television program servers for providing EPG information of television channels via the Internet; and
an EPG processing server for receiving a user's demand from a user device and for providing to the user device user-specific EPG information according to the user's demand,
wherein a plurality of first RSS feeds, for interoperating with the television program servers via the Internet, are registered to the EPG processing server; and
wherein the EPG processing server obtains and stores the EPG information of each television channel by using each of the first RSS feeds, generates the user-specific EPG information corresponding to the user's demand by searching for the stored EPG information according to the user's demand, and provides the user-specific EPG information to the user device.

2. The EPG processing system of claim 1, wherein a plurality of second RSS feeds, about content information relating to television programs in the EPG information, are registered to the EPG processing server.

3. The EPG processing system of claim 2, wherein the content information are updated using the second RSS feeds.

4. The EPG processing system of claim 1, wherein the first RSS feeds have one-to-one correspondence with the television channels.

5. The EPG processing system of claim 1, wherein the stored EPG information are updated by the television program servers using the first RSS feeds.

6. The EPG processing system of claim 1, wherein the EPG processing server includes:
a data storage unit for storing therein the EPG information;
a device profile DB (database) for storing therein device profile information of the user devices;
a device user interface processor for retrieving device profile information of a user device from the device profile DB, converting input EPG information according to the device profile of the user device, and providing to the user device the converted input EPG information as the user-specific EPG information; and
an RSS based main processor for receiving from the user device selection information corresponding to the user-specific EPG information, searching for EPG information corresponding to the selection information in the data storage unit, and providing to the device user interface processor the searched EPG information as input EPG information.

7. An RSS (really simple syndication) feed based EPG (electronic program guide) processing method for use in an EPG processing server, the server generating user-specific electronic program guide information according to a user's demand by using EPG information of television channels provided by a plurality of television program servers via the Internet and providing the user-specific EPG information to a user device, comprising:
registering a first RSS feed for each of the television channels;
obtaining and storing the EPG information using the first RSS feeds;
searching for, when receiving from the user device selection information corresponding to the user-specific EPG information, the stored EPG information based on the selection information; and
generating and providing the user-specific EPG information to the user device.

8. The EPG processing method of claim 7, wherein obtaining and storing the EPG information includes:
receiving basic program information provided by the television channels via the first RSS feeds;
receiving detailed program information linked with the basic program information; and
storing the basic program information and the detailed program information as the EPG information.

9. The EPG processing method of claim 7, further comprising:
registering a plurality of second RSS feeds about content information relating to television programs;
receiving the content information via the second RSS feeds; and
linking the content information with corresponding EPG information and storing the content information.

10. The EPB processing method of claim 7, wherein generating and providing the user-specific EPG information to the user device includes converting the user-specific EPG information based on device profile information of the user device and providing to the user device the converted user-specific EPG information.
